(19) United States
(12) Patent Application Publication
(10) Pub. No.: US 2026/0119259 A1
(43) Pub. Date: Apr. 30, 2026

(54) DISTRIBUTED TRAINING TASK SCHEDULING METHOD, DEVICE, AND NON-VOLATILE READABLE STORAGE MEDIUM

(71) Applicant: Suzhou MetaBrain Intelligent Technology Co., Ltd., Suzhou, Jiangsu (CN)

(72) Inventors: Yingjie KANG, Suzhou, Jiangsu (CN); Dekui WANG, Suzhou, Jiangsu (CN)

(21) Appl. No.: 19/150,799

(22) PCT Filed: Mar. 14, 2024
(86) PCT No.: PCT/CN2024/081740

§ 371 Date: Jul. 24, 2025

(30) Foreign Application Priority Data
Jun. 21, 2023 (CN) 202310740013.1

(51) Int. Cl. G06F 9/50; G06F 18/214

(52) U.S. Cl. CPC G06F 9/5038; G06F 9/5044; G06F 18/214

(57) ABSTRACT

Embodiments of the present application relate to the technical field of computers, and disclose a distributed training task scheduling method and apparatus, a device, and a non-volatile readable storage medium. The method includes: acquiring a scheduling state of each training task, the scheduling state including a successful scheduling state and an unsuccessful scheduling state; acquiring an idle resource quantity of a target cluster resource and a minimum resource demand of first training tasks for the unsuccessfully-scheduled first training tasks; selecting a training task with an allocatable resource from successfully-scheduled second training tasks if the idle resource quantity is less than the minimum resource demand, to obtain the allocatable resource; and performing task scheduling on the first training tasks based on the allocatable resource and the idle resource quantity.

### CROSS-REFERENCE TO RELATED APPLICATION

This application claims priority to Chinese Patent Application No. 2023107400131, filed on Jun. 21, 2023 in China National Intellectual Property Administration and entitled “Distributed Training Task Scheduling Method and Apparatus, Device, and Storage Medium”, which is hereby incorporated by reference in its entirety.

### FIELD

Embodiments of the present application relate to the technical field of computers, in particular, to a distributed training task scheduling method and apparatus, a device, and a non-volatile readable storage medium.

### BACKGROUND

With continuous increase of datasets and model scales, conventional single-machine training methods fail to effectively train large-scale deep neural networks. Therefore, distributed training emerges, that is, a plurality of computers are employed to collaboratively perform model training. However, traditional distributed training struggles to adapt to evolving training demands and data scales, which leads to idle computing nodes, thereby wasting computing resources and increasing a model training cycle.

### SUMMARY

In view of this, embodiments of the present application provide a distributed training task scheduling method and apparatus, a device, and a non-volatile readable storage medium, to solve the problems that traditional distributed training struggles to adapt to evolving training demands and data scales, which leads to idle computing nodes, thereby wasting computing resources and increasing the model training cycle.

In a first aspect, some embodiments of the present application provide a distributed training task scheduling method. The method includes: acquiring a scheduling state of each training task, the scheduling state including a successful scheduling state and an unsuccessful scheduling state; acquiring an idle resource quantity of a target cluster resource and a minimum resource demand of first training tasks, for the first training tasks with the unsuccessfully scheduling state; selecting a training task with an allocatable resource from second training tasks with the successfully scheduling state if the idle resource quantity is less than the minimum resource demand, to obtain the allocatable resource; and performing task scheduling on the first training tasks based on the allocatable resource and the idle resource quantity. By means of the foregoing process, a resource utilization rate and a fault-tolerant capability may be improved greatly, and a model training cycle is shortened.

In some implementations, the scheduling state further includes a protection marker, and the protection marker is configured to determine whether the corresponding training task is in a protection period, where resource allocation may be performed on a training task that is not in the protection period.

In some implementations, the selecting a training task with an allocatable resource from second training tasks with the successfully scheduling state, to obtain the allocatable resource includes:
calculating a resource quantity difference between the idle resource quantity and the minimum resource demand;
selecting a target training task that is not in the protection period and satisfies a resource allocation condition from the second training tasks with the successfully scheduling state based on the resource quantity difference, where the resource allocation condition includes a condition that a resource quantity of the second training tasks is greater than a minimum resource demand of the second training tasks; and
performing resource preemption task scheduling on a preemptable resource in the target training task, to obtain the allocatable resource.

In some implementations, the method further includes:
adding a protection marker to the preempted target training task, to cause the preempted target training task to be in the protection period.

In some implementations, the performing resource preemption task scheduling on a preemptable resource in the target training task includes:
adding the first training tasks into a preemption task queue;
sorting the first training tasks in the preemption task queue; and
sequentially preempting the preemptable resource in the target training task.

In some implementations, the sequentially preempting the preemptable resource in the target training includes:
acquiring instance information corresponding to the resource quantity difference;
determining a difference instance set based on the instance information; and
preempting resources of each instance in the target training task based on an order of resource quantities occupied by each instance in the difference instance set.

In some implementations, the method further includes:
performing task scheduling on the first training tasks based on the idle resource quantity if the idle resource quantity is equal to the minimum resource demand.

In some implementations, the method further includes:
adding a task scheduling operation to an operation list, and updating a scheduling operation result into a local information copy.

In some implementations, the method further includes:
performing task scheduling on the first training tasks based on the idle resource quantity if the idle resource quantity is greater than the minimum resource demand;
acquiring a current idle resource quantity of a cluster resource for the second training tasks with the successfully scheduling state; and
expanding resources corresponding to the second training tasks based on the current idle resource quantity, to increase the resources corresponding to the second training tasks.

In some implementations, the expanding resources corresponding to the second training tasks based on the current idle resource quantity, to increase the resources corresponding to the second training tasks includes:
acquiring the second training tasks that satisfy an expansion condition and are not in the protection period, where the expansion condition includes a condition that a resource quantity of the second training tasks is not a maximum resource demand;
adding the second training tasks into an expansion task queue, and sorting the second training tasks in the expansion task queue; and
sequentially performing an expansion operation on the second training tasks, to increase the resources corresponding to the second training tasks.

In some implementations, the method further includes:
adding the expansion operation to an operation list when succeeding in expansion, and updating an expansion operation result into the local information copy.

In some implementations, the method further includes:
adding a protection marker to each expanded second training task, to cause each expanded second training task to be in the protection period.

In some implementations, the method further includes:
removing the second training tasks from the expansion task queue when the resource quantity of the second training tasks reaches the maximum resource demand;
or stopping the expansion operation when the expansion task queue is void.

In some implementations, the method further includes:
acquiring an expansion-available resource from the idle resources; and
stopping the expansion operation when a utilization rate of the expansion-available resource reaches a utilization threshold, where when the expansion-available resource includes multiple types of resources, a resource with a maximum utilization rate in the multiple types of resources is compared with the utilization threshold.

In some implementations, calculating the minimum resource demand includes:
acquiring instance information carried in the first training task;
determining a minimum instance set based on the instance information; and
determining the minimum resource demand required for proper operation of the first training tasks according to a quantity of resources occupied by each instance in the minimum instance set.

In some implementations, the acquiring a scheduling state of each training task includes:
acquiring training task information of a cluster based on the local information copy;
determining a scheduling training task list according to the training task information; and
determining the scheduling state of each training task based on the scheduling training task list.

In some implementations, the determining a scheduling training task list according to the training task information includes:
acquiring training tasks according to the training task information; and
selecting scheduling training tasks from the training tasks, and generating the scheduling training task list based on the scheduling training tasks.

In some implementations, the method further includes:
saving acquired cluster information and training task information as the local information copy, where the cluster information includes a cluster resource and utilization information of the cluster resource.

In a second aspect, some embodiments of the present application provide a distributed training task scheduling apparatus. The apparatus mainly includes a state acquisition module, a resource acquisition module, a resource allocation module, and a task scheduling module, where the state acquisition module is configured to acquire a scheduling state of each training task, the scheduling state including a successful scheduling state and an unsuccessful scheduling state; the resource acquisition module is configured to acquire an idle resource quantity of a target cluster resource and a minimum resource demand of first training tasks for the first training tasks with the unsuccessfully scheduling state; the resource allocation module is configured to select a training task with an allocatable resource from second training tasks with the successfully scheduling state if the idle resource quantity is less than the minimum resource demand, to obtain the allocatable resource; and the task scheduling module is configured to perform task scheduling on the first training tasks based on the allocatable resource and the idle resource quantity. By means of the foregoing process, a resource utilization rate and a fault-tolerant capability may be improved greatly, and a model training cycle is shortened.

In a third aspect, some embodiments of the present application provides a computer device, including a memory and a processor, where the memory and the processor are in communication connection with each other, the memory has computer instructions stored therein, the processor executes the computer instructions to execute the distributed training task scheduling method in the first aspect or any corresponding implementation.

In a fourth aspect, some embodiments of the present application provides a non-volatile readable storage medium, where the non-volatile readable storage medium has computer instructions stored therein, the computer instructions are configured to enable a computer to execute the distributed training task scheduling method in the first aspect or any corresponding implementation.

### BRIEF DESCRIPTION OF THE DRAWINGS

To describe the technical solutions of implementations of embodiments of the present application or in the prior art more clearly, the accompanying drawings required in the description of the implementations or the prior art are introduced briefly below. Apparently, the accompanying drawings in the following description show some implementations of the present application, and a person of ordinary skill in the art may still derive other drawings from these accompanying drawings without creative efforts.

FIG. 1 is a schematic diagram of an application environment according to some embodiments of the present application;

FIG. 2 is a schematic flowchart of a distributed training task scheduling method according to some embodiments of the present application;

FIG. 3 is a schematic flowchart of another distributed training task scheduling method according to some embodiments of the present application;

FIG. 4 is a schematic flowchart of yet another distributed training task scheduling method according to some embodiments of the present application;

FIG. 5 is a schematic flowchart of yet another distributed training task scheduling method according to some embodiments of the present application;

FIG. 6 is a structural block diagram of a distributed training task scheduling apparatus according to some embodiments of the present application; and

FIG. 7 is a schematic structural diagram of hardware of a computer device according to some embodiments of the present application.

### DETAILED DESCRIPTION

To make the objective, technical solutions and advantages of embodiments of the present application clearer, the technical solutions in the embodiments of the present application are described clearly and completely in conjunction with accompanying drawings in the embodiments of the present application. Apparently, the described embodiments are some embodiments of the present application, not all embodiments. All other embodiments obtained by a person of skill in the art based on the embodiments of the present application without creative efforts shall fall within the protection scope of the present application.

The terms “first”, “second”, and the like in the specification of embodiments of the present application and claims are used to distinguish different objects, rather than describing a specific order of the object. Moreover, the terms “include”, “contain” and any other variants mean to cover the non-exclusive inclusion. For example, a process, a method, a system, a product, or a device that includes a list of steps or units is not necessarily limited to those expressly listed steps or units, but may include other steps or units not expressly listed or inherent to such a process, a method, a system, a product, or a device. In the embodiments of the present application, “a plurality of” may refer to at least two, for example, may be two, three, or more. This is not limited in the embodiments of the present application.

Referring to FIG. 1, FIG. 1 is a schematic diagram of an application environment according to some embodiments of the present application. In the schematic diagram, a computer server 100 may include a display 101, a processor 102, and a memory 103. The computer server 100 may be in communication connection with a management server 200 over a network 300. The management server 200 may be configured to provide services (such as a management service) to computing programs installed on a computing server. A database 201 may be set on the management server 200 or may be independent from the management server 200, and is configured to provide data storage service to the management server 200. In addition, a processing engine 202 may be run in the management server 200, and the processing engine 202 may be configured to execute steps executed by the management server 200.

In some embodiments, the computing server 100 may be, but not limited to, a terminal capable of calculating data, such as a mobile terminal (such as a tablet computer), a notebook computer, and a personal computer (PC), and the network may include, but not limited to, a wireless network or a wired network. The wireless network includes Bluetooth, wireless fidelity (WIFI), and other networks implementing the wireless communication. The foregoing wired network may include, but not limited to: wide area network (WAN), metropolitan area network, and a server cluster. The server 200 may include, but is not limited to, any hardware device capable of performing calculation.

In addition, in the present embodiments, the distributed training task scheduling method may further be applied to, but not limited to, an independent processing device with a high processing capability, without requiring data interaction. For example, the processing device may be, but not limited to, a terminal device with a high processing capability, that is, each operation in the distributed training task scheduling method may be integrated into an independent processing device. The aforementioned description is merely an example. This is not limited in the present embodiments.

In the present embodiments, the distributed training task scheduling method may be executed by the management server 200, or may be executed by the computing server 100, or may be executed collectively by the management server 200 and the computing server 100. The computing server 100 may also employ a client installed thereon to execute the distributed training task scheduling method of the embodiments of the present application.

When in actual application, a communication connection between the management server and each computing server is established first. The management server is configured to take charge of coordinated management of a training process, including data distribution, parameter updating, and so on. The management server may transmit control instructions to computing servers to control the training process and workflow. The computing server is configured to perform actual computing tasks and is responsible for acquiring training data, executing forward calculation and reverse propagation, and other operations, and returning a calculation result to the management server.

According to some embodiments of the present application, provided are distributed training task scheduling method embodiments. It should be noted that steps shown in a flowchart in the accompanying drawing may be executed in a computer system capable of executing a group of computer-executable instructions. Moreover, although a logic sequence is shown in the flowchart, the shown or described steps may be executed in a different sequence in some cases.

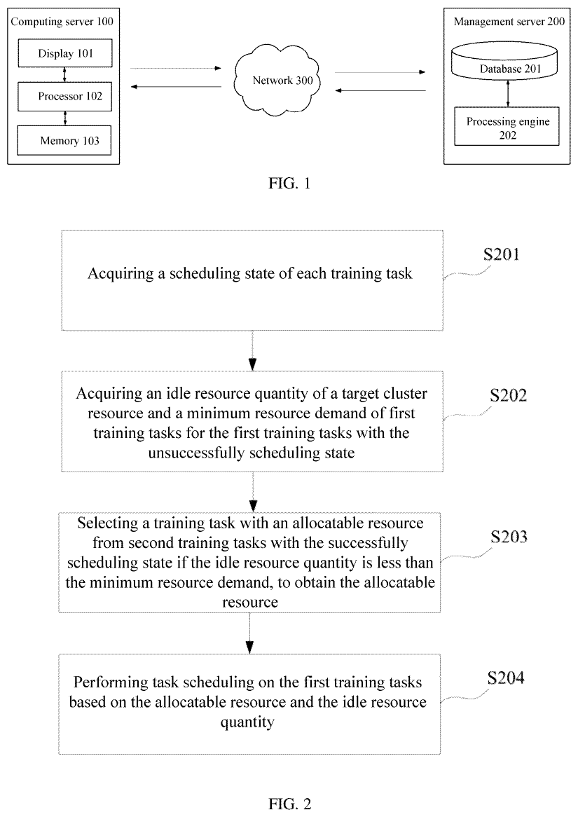

The present embodiments provide a distributed training task scheduling method, which may be applied to the foregoing computing server. FIG. 2 is a flowchart of a distributed training task scheduling method according to some embodiments of the present application. As shown in FIG. 2, the process includes the following steps:
Step S201: acquiring a scheduling state of each training task.

In the present embodiments, the scheduling state of each training task is acquired, whereby whether resource scheduling needs to be performed on the training task is determined according to the scheduling state of each training task.

In some implementations, cluster information and training task information are periodically acquired from an artificial intelligence (AI) training platform, and then acquired cluster information and acquired training task information are saved as a local information copy. In the present embodiments, after the cluster information and the training task information are acquired from the AI training platform, new information update in the platform may not be acknowledged within a current scheduling cycle. In the present embodiments, the scheduling cycle is one second, that is, the task scheduling is performed every one second. In other embodiments, the scheduling cycle may also be adjusted according to actual requirements, and non-periodic scheduling may also be performed.

In some embodiments, the cluster information includes a cluster resource (such as computing server information and management server information of a cluster), and utilization information of the cluster resource (such as a total quantity, a used quantity, and an available quantity of various resources in the cluster), and the total quantity of various resources in the cluster is a sum of quantities of various resources such as a host central processing unit (CPU), graphics processing unit (GPU), and memory.

It may be understood that the cluster information and the training task information are copied as the local information copy of the management server (a scheduler in the management server), whereby only the resource in the local information copy is changed in a process of trying to schedule the unsuccessfully-scheduled training task or returning the unsuccessfully-scheduled training task, and an impact of the process on the resource state in the cluster is avoided.

In some implementations, the training task information of the cluster may be acquired based on the local information copy, then training tasks are acquired according to the training task information, scheduling training tasks are selected from the training tasks, a scheduling training task list is generated based on the scheduling training tasks, and then the scheduling state of each training task is determined based on the scheduling training task list. The scheduling state includes a successful scheduling state and an unsuccessful scheduling state, and the successful scheduling state may include a successful scheduling state in a current scheduling cycle and a successful scheduling state in a past scheduling cycle.

In some embodiments, the scheduling state of each training task is determined based on the training task list, and if the training task is in the unsuccessful scheduling state, the unsuccessfully-scheduled training tasks in the training task list may be sorted, and first training tasks are determined sequentially. The unsuccessfully-scheduled training tasks may be sorted according to an ascending order of minimum resources required for operations of the training tasks, or may be sorted based on creation time of the training tasks and an unsuccessfully-scheduled order. It may be understood that the unsuccessfully-scheduled training tasks in the training task list are sorted to improve the efficiency of determining the first training tasks; and moreover, the first training tasks that need to be scheduled as soon as possible may be scheduled as soon as possible, thereby avoiding a situation that the same first training task is not scheduled for multiple times or not scheduled for a long time, and meeting actual application requirements.

In some implementations, each first training task includes characters such as a master/launcher and a worker, and each character may have a plurality of instances. When the distributed training task is created, a resource quantity required by each instance is fixed. However, in the embodiments, the quantity of the instances is variable, and may have a maximum value and a minimum value. When the quantity of the instances is the maximum value, a maximum resource quantity required for proper operation of the first training tasks, i.e., a maximum resource demand, may be obtained. When the quantity of the instances is the minimum value, a minimum resource quantity required for proper operation of the first training tasks, i.e., a minimum resource demand may be obtained.

The master/launcher is a management character in the training task, and is responsible for the coordinated management of the training process, including data distribution, parameter updating, and the like. The master/launcher may transmit the control instructions to workers to control a training process and workflow.

The worker is a computing character in the training task and is responsible for acquiring training data, executing forward calculation and reverse propagation, and other operations, and returning a calculation result to the management character.
Step S202: acquiring an idle resource quantity of a target cluster resource and a minimum resource demand of first training tasks, for the first training tasks with the unsuccessfully scheduling state.

In the present embodiments, for the first training tasks with the successfully scheduling state, the idle resource quantity of the target cluster resource and the minimum resource demand of the first training tasks are acquired, whereby the minimum resource demand required for operation is allocated to the first training tasks, thereby avoiding termination of subsequent training of the unsuccessfully-scheduled training task caused by insufficient cluster resource, and improving the resource utilization rate.

In some implementations, instance information carried in the first training tasks may be acquired first, then a minimum instance set is determined based on the instance information, and the minimum resource demand required for proper operation of the first training tasks, i.e., the minimum resource demand is determined according to a quantity of resources occupied by each instance in the minimum instance set. Then the idle resource quantity in the cluster resource is acquired, and when the idle resource quantity reaches the minimum resource demand, that is, the idle resource quantity is greater than or equal to the minimum resource demand, task scheduling is performed on the first training tasks based on the idle resource quantity, and the first training tasks are marked as being scheduled successfully. Finally, a task scheduling operation of the first training tasks is added to an operation list, and a scheduling operation result is updated into a local information copy to record the scheduling operation. Similarly, the instance information carried in the first training tasks may be acquired first, then a maximum instance set is determined based on the instance information, and a maximum resource quantity required for proper operation of the first training tasks, i.e., a maximum resource demand is determined according to the quantity of resources occupied by each instance in the maximum instance set. The scheduling operation involves determining which instances of the master/launcher and which instances of the workers are to be scheduled onto which computing server.

In practical implementation, a number of instances in the minimum instance set may be multiplied by the quantity of resources occupied by the instances for summation calculation to obtain the minimum resource demand required for the proper operation of the first training tasks. Similarly, the number of the instances in the maximum instance set is multiplied by the quantity of resources occupied by the instances for summation calculation to obtain a maximum resource demand required for proper operation of the first training tasks.

In some implementations, the resource among the idle resources may be invoked based on the quantity of resources occupied by each instance in the minimum instance set; and after instances in the minimum instance set complete the resource scheduling, the first training tasks are marked as being successfully scheduled.

It should be understood that when the minimum resource demand required for proper operation of the first training tasks is allocated to the first training tasks, each instance in the minimum instance set may continuously invoke the idle resources according to the idle resource quantity when there are idle resources in the cluster resource until all instances in the minimum instance set complete the resource scheduling, whereby it is considered that the first training tasks are marked as being successfully scheduled. That is, the idle resources in the cluster resource may not be a complete resource, but a sum of idle resources of a plurality of computing servers, and when each instance in the unsuccessfully-scheduled training task is scheduled, the scheduling may be completed at one time or multiple times.

In some embodiments, the scheduling state further includes a protection marker, and the protection marker is configured to determine whether the corresponding training task is in a protection period, where resource allocation may be performed on the training task that is not in the protection period.
Step S203: selecting a training task with an allocatable resource from second training tasks with the successfully scheduling state if the idle resource quantity is less than the minimum resource demand, to obtain the allocatable resource.

In the present embodiments, when the idle resource quantity in a cluster resource is less than the minimum resource demand, that is, when the idle resource quantity is insufficient, the training task with the allocatable resource is selected from the second training tasks with the successfully scheduling state to obtain the allocatable resource, thereby improving an overall resource utilization rate of the cluster.

In some implementations, a resource quantity difference between the idle resource quantity and the minimum resource demand is calculated first; a target training task that is not in the protection period and satisfies a resource allocation condition is selected from the second training tasks with the successfully scheduling state; and the resource preemption task scheduling is performed on a preemptable resource in the target training task to obtain the allocatable resource. The resource allocation condition includes a condition that a resource quantity of the second training tasks is greater than a minimum resource demand of the second training tasks.

In some embodiments, when the resource preemption task scheduling is performed on the preemptable resource in the target training task, the first training tasks may be added into a preemption task queue, then the first training tasks in the preemption task queue are sorted, and subsequently, the preemptable resource in the target training task is preempted sequentially.

In some embodiments, when the preemptable resource in the target training task is preempted sequentially, the instance information corresponding to the resource quantity difference may be acquired, then a difference instance set is determined based on the instance information, and finally the resources of the instances in the target training task are preempted according to an order of the resource quantities occupied by the instances in the difference instance set.

In the present implementation, when the idle resources in the current cluster resource are insufficient, the resource of the target training task in the second training tasks that are successfully scheduled, are not in the protection period and satisfy the resource allocation condition is preempted to improve the overall resource utilization rate of the cluster. The training task that is in the protection period may not be expanded and preempted. By setting the protection period, the training failure caused by frequent expansion and reduction may be avoided, and the stability is improved.

A preemption operation involves removing certain instances of certain masters/launchers and workers from certain computing servers, and labeling the affected second training tasks with a protection period marker.

In some implementations, the successfully-scheduled second training tasks are acquired from a local information copy, a target training task is determined from the second training tasks that are not in the protection period and satisfy a resource allocation condition, and the resource in the target training task is added into a resource preemption queue. The unsuccessfully-scheduled first training tasks are acquired from the local information copy, and the first training tasks are added into a preemption task queue. The first training tasks in the preemption task queue are sorted. Finally, the resources of the target training tasks are preempted sequentially. The first training tasks in the preemption task queue may be sorted according to an ascending order of minimum resources required for operation of the first training tasks, or may be sorted based on creation time of the first training tasks and an unsuccessfully-scheduled order. In the present implementation, the first training tasks in the preemption task queue are sorted to improve the selection efficiency of the first training tasks, and the unsuccessfully-scheduled first training tasks that need to be scheduled as soon as possible may be scheduled as soon as possible, thereby avoiding a situation that the same unsuccessfully-scheduled training task is not scheduled for multiple times or not scheduled for a long time, and meeting actual application requirements.

In some implementations, in a case of insufficient idle resource quantity, the resource (the resource exceeding the minimum resource demand) of the target training task that is not in the protection period and satisfies the resource allocation condition in the successfully-scheduled second training tasks is added into the resource preemption queue. The first training tasks in the local information copy are added into the preemption task queue and sorted, then the resource preemption queue is traversed sequentially, the resource corresponding to an instance (the preempted) of the to-be-preempted target training task is determined according to the resource information (such as each resource quantity in a resource set) of the resource preemption queue, and then an attempt on evicting the preempted from these computing servers (deleting the preempted from the computing servers, and releasing the resource) is made.

In some implementations, the training task information of the cluster may be acquired based on the local information copy, and the successfully-scheduled second training tasks may be determined according to the training task information. At the same time, the scheduling operation and expansion operation information of each second training task may be acquired based on the local information copy, whereby whether the resource quantity scheduled by the second training tasks is already greater than the minimum resource demand is determined. When the current resource quantity of the second training tasks is greater than the minimum resource demand, it is considered that the second training tasks satisfy the resource allocation condition. Whether the second training tasks are not in the protection period may be determined based on the protection marker carried by the second training tasks. The protection marker may be marker information with a time stamp. The resource of the target training task in the second training tasks that are successfully scheduled, are not in the protection period and satisfy the resource allocation condition is added into a resource preemption queue, whereby the resources corresponding to certain instances in each target training task in the resource preemption queue are preempted.
Step S204: performing task scheduling on the first training tasks based on the allocatable resource and the idle resource quantity.

In the present embodiments, the task scheduling is performed on the first training tasks based on the allocatable resource and the idle resource quantity, which provides a necessary condition for normal training of the first training tasks.

In some implementations, the minimum resource demand required for proper operation of the first training tasks may be acquired. Then the resource preemption queue is traversed sequentially based on the instances corresponding to the minimum resource demand, and the resource corresponding to a certain instance (the preempted) of the to-be-preempted target training task is determined according to the resource information (such as each resource quantity in a resource set) of the resource preemption queue. Finally, an attempt on evicting the preempted from these computing servers (deleting the preempted from the computing server and releasing the resource) is made, when the quantity of resources preempted by the unsuccessfully-scheduled training task reaches the required minimum resource demand (that is, all instances in the minimum instance set complete the resource preemption), the first training tasks are marked as being scheduled successfully, the task scheduling operation is added to the operation list, and the scheduling operation result is updated into the local information copy.

In the distributed training task scheduling method provided in the present embodiments, the scheduling state of each training task is acquired first to determine whether resource scheduling needs to be performed on the training task according to the scheduling state of each training task. For the unsuccessfully-scheduled first training tasks, the idle resource quantity of the cluster resource and the minimum resource demand of the first training tasks are acquired, whereby the minimum resource demand required for operation is allocated to the first training tasks, thereby avoiding the termination of subsequent training of the unsuccessfully-scheduled training task caused by insufficient resource of the cluster, and improving the resource utilization rate. When the idle resource quantity in the cluster resource is less than the minimum resource demand, that is, the idle resource quantity is insufficient, the training task with the allocatable resource is selected from the second training tasks with the successfully scheduling state to obtain the allocatable resource, thereby improving the overall resource utilization rate of the cluster. The task scheduling is performed on the first training tasks according to the allocatable resource and the idle resource quantity, which provides a necessary condition for normal training of the first training tasks. Therefore, the present embodiments of the present application may greatly improve the resource utilization rate and fault-tolerant capability, and shorten the model training cycle.

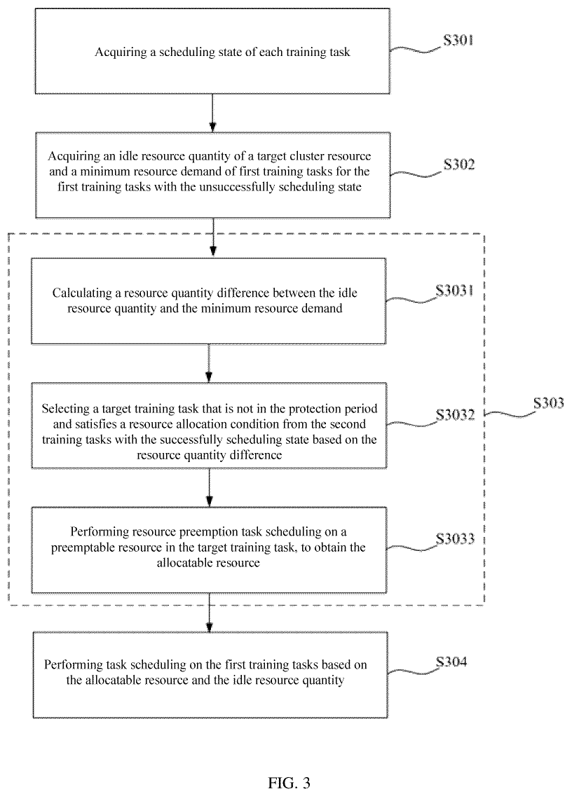

The present embodiments provide a distributed training task scheduling method, which may be applied to the foregoing computing server. FIG. 3 is a flowchart of a distributed training task scheduling method according to some embodiments of the present application. As shown in FIG. 3, the process includes the following steps:
Step S301: acquiring a scheduling state of each training task.

In the present embodiments, the scheduling state of each training task is acquired, whereby whether resource scheduling needs to be performed on the training task is determined according to the scheduling state of each training task.

For detail descriptions, refer to Step S201 in the embodiments shown in FIG. 2. Details are not described herein again.
Step S302: acquiring an idle resource quantity of a target cluster resource and a minimum resource demand of first training tasks, for the first training tasks with the unsuccessfully scheduling state.

In the present embodiments, for the first training tasks with the unsuccessfully scheduling state, the idle resource quantity of the target cluster resource and the minimum resource demand of the first training tasks are acquired, whereby the minimum resource demand required for operation is allocated to the first training tasks, thereby avoiding termination of subsequent training of the unsuccessfully-scheduled training task caused by insufficient cluster resource, and improving the resource utilization rate.

For detail descriptions, refer to Step S202 in the embodiments shown in FIG. 2. Details are not described herein again.
Step S303: performing task scheduling on the first training tasks based on the idle resource quantity if the idle resource quantity is greater than the minimum resource demand.

In the present embodiments, when the idle resource quantity in the cluster resource is less than the minimum resource demand, that is, when the idle resources are insufficient, the training task with the allocatable resource is selected from second training tasks with the successfully scheduling state to preempt resources corresponding to certain instances in the target training task, thereby improving the overall resource utilization rate of the cluster.

In some embodiments, the foregoing Step S303 includes:
Step S3031: calculating a resource quantity difference between the idle resource quantity and the minimum resource demand.

In the present embodiments, when the idle resource quantity in the cluster resource is less than the minimum resource demand, that is, the idle resource quantity is insufficient, the resource quantity difference between the idle resource quantity and the minimum resource demand is first calculated, whereby the target training task that satisfies a resource allocation condition is determined based on the resource quantity difference.
Step S3032: selecting a target training task that is not in the protection period and satisfies the resource allocation condition from the second training tasks with the successfully scheduling state based on the resource quantity difference.

In the present embodiments, the target training task that is not in the protection period and satisfies the resource allocation condition is selected from the successfully-scheduled second training tasks based on the resource quantity difference to preempt resources corresponding to the certain instances in the target training task.

In some implementations, training task information of a cluster may be acquired based on a local information copy, and the successfully-scheduled second training tasks may be determined according to the training task information. At the same time, scheduling operation and expansion operation information of each second training task may also be acquired based on the local information copy, whereby whether the resource quantity scheduled by the second training tasks is already greater than a minimum resource demand is determined. When the current resource quantity of the second training tasks is greater than the minimum resource demand, it is considered that the second training tasks satisfy the resource allocation condition. Whether the second training tasks are not in the protection period may be determined based on the protection marker carried by the second training tasks. The protection marker may be marker information with a time stamp. The resource of the target training task in the second training tasks that are successfully scheduled, are not in the protection period and satisfy the resource allocation condition is added into a resource preemption queue, whereby the resources corresponding to certain instances in each target training task in the resource preemption queue are preempted.
Step S3033: performing resource preemption task scheduling on the preemptable resource in target training task to obtain the allocatable resource.

In the present embodiments, the resource preemption task scheduling is performed on the preemptable resource in the target training task to obtain the allocatable resource, thereby improving the overall resource utilization rate of the cluster.

In some implementations, task scheduling during resource preemption is first performed on the preemptable resource in the target training task, the first training tasks may be added into a preemption task queue, subsequently the first training tasks in the preemption task queue are sorted, and then the preemptable resource in the target training task is preempted sequentially.

In some embodiments, when the preemptable resource in the target training task is preempted sequentially, instance information corresponding to the resource quantity difference may be acquired, then a difference instance set is determined based on the instance information, and finally, the resources of the instances in the target training task are preempted according to an order of the resource quantities occupied by the instances in the difference instance set.

In some implementations, the successfully-scheduled second training tasks are acquired from a local information copy, a target training task is determined from the second training tasks that are not in the protection period and satisfy a resource allocation condition, and the resource in the target training task is added into a resource preemption queue. Unsuccessfully-scheduled first training tasks are acquired from the local information copy, and the first training tasks are added into a preemption task queue. The first training tasks in the preemption task queue are sorted. Finally, the resources of the target training tasks are preempted sequentially. The first training tasks in the preemption task queue may be sorted according to an ascending order of minimum resources required for operation of the first training tasks, or may be sorted based on creation time of the first training tasks and an unsuccessfully-scheduled order. In the present implementation, the first training tasks in the preemption task queue are sorted to improve the selection efficiency of the first training tasks, and the unsuccessfully-scheduled first training tasks that need to be scheduled as soon as possible may be scheduled as soon as possible, thereby avoiding a situation that the same unsuccessfully-scheduled training task is not scheduled for multiple times or not scheduled for a long time, and meeting actual application requirements.

In some implementations, in a case of insufficient idle resource quantity, the resource (the resource exceeding the minimum resource demand) of the target training task that is not in the protection period and satisfies the resource allocation condition in the successfully-scheduled second training tasks is added into a resource preemption queue. The first training tasks in the local information copy are added into a preemption task queue and sorted, then the resource preemption queue is traversed sequentially, the resource corresponding to an instance (the preempted) of the to-be-preempted target training task is determined according to the resource information (such as each resource quantity in the resource set) of the resource preemption queue, and an attempt on evicting the preempted from these computing servers (deleting the preempted from the computing servers and releasing the resource) is made.

In some implementations, a protection marker is added to the preempted target training task, to cause the preempted target training task to be in the protection period.

It may be understood that when the cluster resource is insufficient, the resource of the target training task that is successfully scheduled, is not in the protection period and satisfies the resource allocation condition is preempted to improve the overall resource utilization rate of the cluster. The training task that is in the protection period may not be expanded and preempted. By setting the protection period, the training failure caused by frequent expansion and reduction may be avoided, and the stability is improved.
Step S304: performing task scheduling on the first training task based on the allocatable resource and the idle resource quantity.

In the present embodiments, task scheduling is performed on the first training tasks based on the allocatable resources and the idle resource quantity, which provides a necessary condition for normal training of the first training tasks.

For detail descriptions, refer to Step S204 in the embodiments shown in FIG. 2. Details are not described herein again.

In the distributed training task scheduling method provided in the present embodiments, the scheduling state of each training task is acquired first to determine whether resource scheduling needs to be performed on the training task according to the scheduling state of each training task. For the unsuccessfully-scheduled first training tasks, the idle resource quantity of the cluster resource and the minimum resource demand of the first training tasks are acquired, whereby the minimum resource demand required for operation is allocated to the first training tasks, thereby avoiding the termination of subsequent training of the unsuccessfully-scheduled training task caused by the insufficient cluster resource, and improving the resource utilization rate. When the idle resource quantity in the cluster resource is less than the minimum resource demand, that is, the idle resource quantity is insufficient, the training task with the allocatable resource is selected from the second training tasks with the successfully-scheduling state to obtain the allocatable resource, thereby improving the overall resource utilization rate of the cluster; and the task scheduling is performed on the first training tasks according to the allocatable resource and the idle resource quantity, which provides a necessary condition for normal training of the first training tasks. Therefore, the present embodiments of the present application may greatly improve the resource utilization rate and fault-tolerant capability, and shorten the model training cycle.

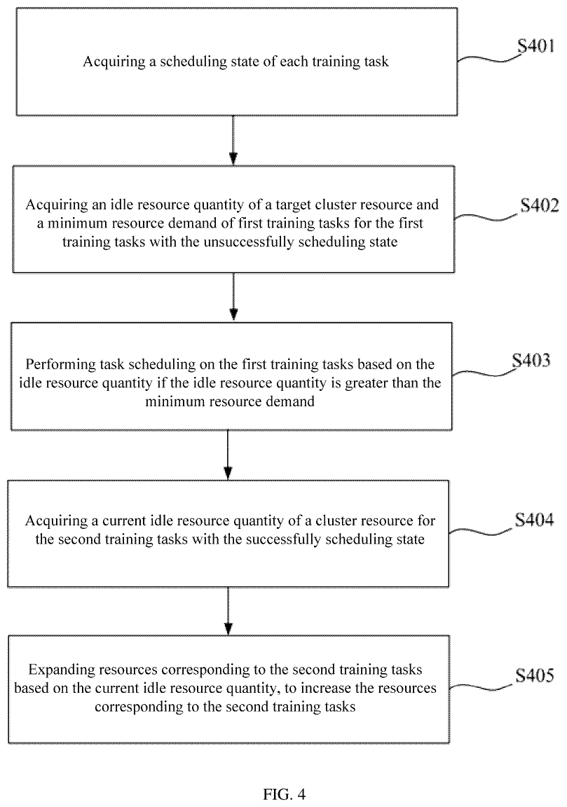

The present embodiments provide a distributed training task scheduling method, which may be applied to the foregoing computing server. FIG. 4 is a flowchart of a distributed training task scheduling method according to some embodiments of the present application. As shown in FIG. 4, the process includes the following steps:
Step S401: acquiring a scheduling state of each training task.

In the present embodiments, the scheduling state of each training task is acquired, whereby whether resource scheduling needs to be performed on the training task is determined according to the scheduling state of each training task.

For detail descriptions, refer to Step S201 in the embodiments shown in FIG. 2. Details are not described herein again.
Step S402: acquiring an idle resource quantity of a target cluster resource and a minimum resource demand of first training tasks, for the first training tasks with the unsuccessfully scheduling state.

In the present embodiments, for the first training tasks with the unsuccessfully scheduling state, the idle resource quantity of the target cluster resource and the minimum resource demand of the first training tasks are acquired, whereby the minimum resource demand required for operation is allocated to the first training tasks, thereby avoiding termination of subsequent training of the unsuccessfully-scheduled training task caused by insufficient cluster resource, and improving the resource utilization rate.

For detail descriptions, refer to Step S202 in the embodiments shown in FIG. 2. Details are not described herein again.
S403: performing task scheduling on the first training tasks based on the idle resource quantity if the idle resource quantity is greater than the minimum resource demand.

In the present embodiments, if the idle resource quantity is greater than the minimum resource demand, task scheduling is performed on the first training tasks based on the idle resource quantity, thereby avoiding the termination of subsequent training of the unsuccessfully-scheduled training task caused by insufficient cluster resource, and improving the resource utilization rate.

In some implementations, the instance information carried in the first training tasks may be acquired first, then the minimum instance set is determined based on the instance information, and the minimum resource demand required for proper operation of the first training tasks is determined according to the quantity of resources occupied by each instance in the minimum instance set. The idle resource quantity in the cluster resource is acquired, and when the idle resource quantity reaches the minimum resource demand, the first training tasks are marked as being successfully scheduled. Finally, a task scheduling operation of the first training tasks is added to an operation list, and a scheduling operation result is updated into a local information copy to record the scheduling operation. Similarly, the instance information carried in the first training tasks may be acquired first, then a maximum instance set is determined based on the instance information, and a maximum resource demand required for proper operation of the first training tasks is determined according to the quantity of resources occupied by each instance in the maximum instance set. The scheduling operation involves determining which instances of the master/launcher and which instances of the workers are to be scheduled onto which computing servers.

In practical implementation, a number of instances in the minimum instance set may be multiplied by the quantity of resources occupied by the instances for summation calculation to obtain the minimum resource demand required for the proper operation of the first training tasks. Similarly, a number of instances in the maximum instance set may be multiplied by the quantity of resources occupied by the instances for summation calculation to obtain the maximum resource demand required for the proper operation of the first training tasks.

In some implementations, the resource may be invoked from the idle resources based on the quantity of resources occupied by each instance in the minimum instance set. After all instances in the minimum instance set complete the resource scheduling, the first training tasks are marked as being successfully scheduled.

It should be understood that when the minimum resource demand required for the proper operation of the first training tasks is allocated to the first training tasks, each instance in the minimum instance set may continuously invoke the idle resources according to the idle resource quantity when there are idle resources in the cluster resource until all instances in the minimum instance set complete the resource scheduling, whereby it is considered that the first training tasks are marked as being successfully scheduled. That is, the idle resources in the cluster resource may not be a complete resource, but a sum of all idle resources of a plurality of computing servers, and when each instance in the first training tasks is scheduled, the scheduling may be completed at one time or multiple times.
Step S404: acquiring a current idle resource quantity of the cluster resource for the second training tasks with the successfully scheduling state.

In the present embodiments, for the second training tasks with the successfully scheduling state, the current idle resource quantity of the cluster resource is acquired to determine whether the resources of the second training tasks may be expanded to reduce a ratio of idle resources in the cluster, thereby improving the overall resource utilization rate of the cluster.

In some implementations, when the expansion-available resource in the idle resources fails to reach a utilization threshold, the idle resources in the expansion-available resource is utilized to expand the resources for the second training tasks that are successfully scheduled, are not in the protection period and satisfy an expansion condition. The expansion-available resource refers to the resource on the computing servers remaining in the cluster after excluding those computing servers that may be used by the unsuccessfully-scheduled training tasks. In extreme cases where unsuccessfully-scheduled training tasks may utilize all computing servers, this means that the resources are insufficient, and the expansion-available resource is zero.

An expansion operation involves respectively scheduling certain instances of masters/launchers and workers onto certain computing servers, and labeling the affected target training tasks with a protection period marker.

In some embodiments, the second training tasks that are successfully scheduled, satisfy an expansion condition and are not in the protection period may be acquired first from a local information copy. Then the second training tasks are added into an expansion task queue, and the second training tasks in the expansion task queue are sorted. The second training tasks are expanded sequentially, an expansion operation is added to the operation list when succeeding in expansion, and an expansion operation result is updated into the local information copy. The second training tasks in the expansion task queue may be sorted according to an ascending order of minimum resources required for operations of the second training tasks, or may be sorted according to creation time of the second training tasks and an unsuccessfully-scheduled order. In the present implementation, the second training tasks in a second training queue are sorted to improve the efficiency of determining the second training tasks. Moreover, the second training tasks that need to be scheduled as soon as possible may be scheduled as soon as possible, thereby avoiding a situation that the same second training task is not scheduled for multiple times or not scheduled for a long time, and meeting actual application requirements.

It may be understood that in a case of sufficient cluster resource, when resource expansion is performed on the second training tasks, the remaining instances in the maximum instance set after the minimum instance set and the invoked instances are removed may be used as an expandable part, then idle resource invoking is continuously performed on the expandable part, and the expansion operation is added into the operation list when succeeding in expansion. That is, the idle resources in the cluster resource may not be a complete resource, but a sum of idle resources of a plurality of computing servers, and when the instance that needs to be expanded in the second training tasks is scheduled, the scheduling may be completed at one time or multiple times.
Step S405: expanding resources corresponding to the second training tasks based on the current idle resource quantity, to increase the resources corresponding to the second training tasks.

In the present embodiments, the resources corresponding to the second training tasks are increased by expanding the resources corresponding to the second training tasks based on the current idle resource quantity, thereby improving the training efficiency of the second training tasks.

In some implementations, the expansion task queue may also be cyclically traversed according to the resource information of the idle resources (such as each resource quantity in the resource set), an attempt on expanding an instance for the second training tasks every time is made, the expansion operation is added to the operation list when succeeding in expansion, and the expansion operation result is updated into the local information copy.

In some implementations, when the resource quantity of the second training tasks reaches the maximum resource demand, the second training tasks are removed from the expansion task queue. Or, the expansion operation is stopped when the expansion task queue is void. The expansion-available resource in the idle resources may also be acquired, and when a utilization rate of the expansion-available resource reaches a utilization threshold, the expansion operation is stopped. When the expansion-available resource includes multiple types of resources, a resource with a maximum utilization rate in the multiple types of resources is compared with the utilization threshold, and the utilization threshold may be 80% of the expansion-available resource, and may be adjusted according to actual requirements in other embodiments. By setting the utilization threshold, waiting of subsequent newly created training tasks is avoided.

In the distributed training task scheduling method provided in the present embodiments, the scheduling state of each training task is acquired first to determine whether resource scheduling needs to be performed on the training task according to the scheduling state of each training task. For the first training tasks with the unsuccessfully scheduling state, the idle resource quantity of the cluster resource and the minimum resource demand of the first training tasks are acquired, whereby the minimum resource demand required for operation is allocated to the first training tasks, thereby avoiding termination of subsequent training of the unsuccessfully-scheduled training task caused by insufficient cluster resource, and improving the resource utilization rate. When the idle resource quantity is greater than the minimum resource demand, task scheduling is performed on the first training tasks based on the idle resource quantity, thereby avoiding termination of subsequent training of the unsuccessfully-scheduled training task caused by insufficient cluster resource, and improving the resource utilization rate. For the second training tasks with the successfully scheduling state, the current idle resource quantity of the cluster resource is acquired, to determine whether the resources of the second training tasks may be expanded, thereby reducing a ratio of idle resources in the cluster, and improving the overall resource utilization rate of the cluster. Therefore, the present embodiments of the present application may greatly improve the resource utilization rate and fault-tolerant capability, and shorten the model training cycle.

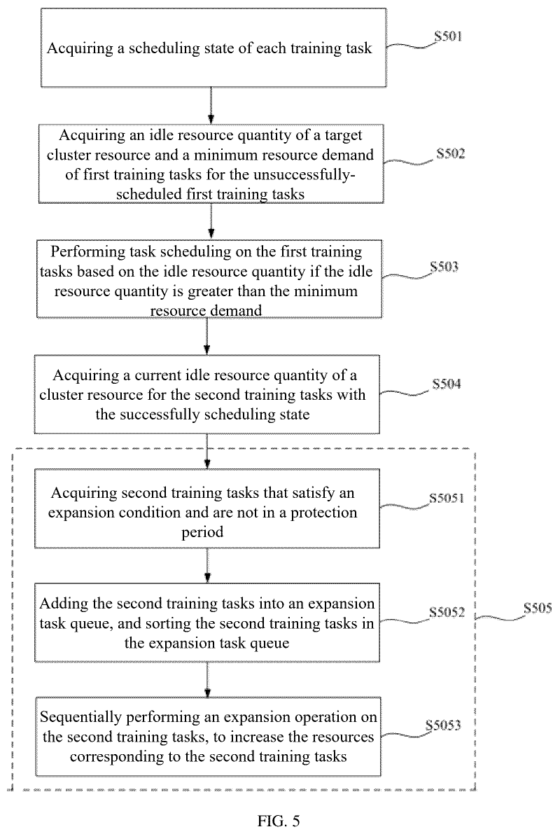

The present embodiments provide a distributed training task scheduling method, which may be applied to the foregoing computing server. FIG. 5 is a flowchart of a distributed training task scheduling method according to some embodiments of the present application. As shown in FIG. 5, the process includes the following steps:
Step S501: acquiring a scheduling state of each training task.

In the present embodiments, the scheduling state of each training task is acquired, whereby whether resource scheduling needs to be performed on the training task is determined according to the scheduling state of each training task.

For detail descriptions, refer to Step S201 in the embodiments shown in FIG. 2. Details are not described herein again.
Step S502: acquiring an idle resource quantity of a target cluster resource and a minimum resource demand of first training tasks, for he first training tasks with the unsuccessfully scheduling state.

In the present embodiments, for the unsuccessfully-scheduled first training tasks, the idle resource quantity of the target cluster resource and the minimum resource demand of the first training tasks are acquired, whereby the minimum resource demand required for operation is allocated to the first training tasks, thereby avoiding termination of subsequent training of the unsuccessfully-scheduled training task caused by insufficient cluster resource, and improving the resource utilization rate.

For detail descriptions, refer to Step S202 in the embodiments shown in FIG. 2. Details are not described herein again.
S503: performing task scheduling on the first training tasks based on the idle resource quantity if the idle resource quantity is greater than the minimum resource demand.

In the present embodiments, if the idle resource quantity is greater than the minimum resource demand, task scheduling is performed on the first training tasks based on the idle resource quantity, thereby avoiding the termination of subsequent training of the unsuccessfully-scheduled training task caused by insufficient cluster resource, and improving the resource utilization rate.

For detail descriptions, refer to Step S403 in the embodiments shown in FIG. 4. Details are not described herein again.
Step S504: acquiring a current idle resource quantity of a cluster resource for the second training tasks with the successfully scheduling state.

In the present embodiments, for the second training tasks with the successfully scheduling state, the current idle resource quantity of the cluster resource is acquired to determine whether the resources of the second training tasks may be expanded to reduce a ratio of idle resources in a cluster, thereby improving the overall resource utilization rate of the cluster.

For detail descriptions, refer to Step S404 in the embodiments shown in FIG. 4. Details are not described herein again.
Step S505: expanding the resources corresponding to the second training tasks based on the current idle resource quantity, to increase the resources corresponding to the second training tasks.

In the present embodiments, the resources corresponding to the second training tasks are increased by expanding the resources corresponding to the second training tasks based on the current idle resource quantity, thereby improving the training efficiency of the second training tasks.

In some embodiments, the foregoing Step S505 includes:
Step S5051: acquiring second training tasks that satisfy an expansion condition and are not in a protection period.

In the present embodiments, the second training tasks that satisfy the expansion condition and are not in the protection period is acquired, whereby the resource of the second training tasks is expanded.

In some implementations, training task information of a cluster may be acquired based on a local information copy, and the successfully-scheduled second training tasks may be determined according to the training task information. At the same time, scheduling operation and expansion operation information of each second training task may be acquired according to the local information copy, whereby whether the resource quantity scheduled by the second training tasks already reaches the maximum resource demand is determined. When the current resource quantity of the second training tasks fails to reach the maximum resource demand, it is considered that each second training task satisfies the expansion condition. Whether each second training task is in the protection period may be determined based on a protection marker carried by each second training task. The protection marker may be marker information with a time stamp.
Step S5052: adding the second training tasks into an expansion task queue, and sorting the second training tasks in the expansion task queue.

In the present implementation, the second training tasks are added into the expansion task queue, and the second training tasks in the expansion task queue are sorted to improve the efficiency of determining the second training tasks. Moreover, each second training task that needs to be scheduled as soon as possible may be scheduled as soon as possible, thereby avoiding the situation that the same second training task is not expanded for multiple times or not expanded for a long time, and meeting actual application requirements.

In some implementations, the second training tasks are first added into the expansion task queue, and then sorted according to an ascending order of minimum resources required for operations of the second training tasks, or sorted in an ascending order according to creation time of the second training tasks, or sorted according to an order in which the second training tasks are unsuccessfully expanded and a priority level.
Step S5053: sequentially performing an expansion operation on the second training tasks, to increase the resources corresponding to the second training tasks.

In the present embodiments, the expansion operation is performed sequentially on the second training tasks, to increase the resources corresponding to the second training tasks, thereby improving the training efficiency of the second training tasks.

In some implementations, remaining instances in a maximum instance set after a minimum instance set and invoked instances are removed are used as an expandable part, then idle resource invoking is continuously performed on the expandable part, and the expansion operation is added into the operation list when succeeding in expansion. That is, the idle resources in the cluster resource may not be a complete resource, but a sum of idle resources of a plurality of computing servers, and when the instances that need to be expanded in a target training task are scheduled, the scheduling may be completed at one time or multiple times.

In some implementations, in a case of sufficient cluster resource, the expansion task queue may also be cyclically traversed according to resource information of the idle resources (such as each resource quantity in a resource set), an attempt on expanding an instance for each second training task is made, the expansion operation is added to the operation list when succeeding in expansion, and the expansion operation is updated into the local information copy.

In some implementations, when the resource quantity of the second training tasks reaches the maximum resource demand, the second training tasks are removed from the expansion task queue. Or, the expansion operation is stopped when the expansion task queue is void. The expansion-available resource in the idle resources may also be acquired, and when the utilization rate of the expansion-available resource reaches a utilization threshold, the expansion operation is stopped. When the expansion-available resource includes multiple types of resources, a resource with a maximum utilization rate in the multiple types of resources is compared with the utilization threshold, and the utilization threshold may be 80% of the expansion-available resources, and may be adjusted according to actual requirements in other embodiments. By setting the utilization threshold, waiting of subsequent newly created training tasks is avoided.

In some implementations, a protection marker may also be added to each expanded second training task, to cause each expanded second training task to be in the protection period.

It may be understood that by adding the protection marker to each expanded second training task, each second training task is prevented from being affected again within a short time after being affected by the expansion operation. The protection period may be calculated from the completion of previous flexible task expansion or reduction, or may be calculated from the end of the previous scheduling cycle, and a protection duration may be adjusted according to the requirement of the second training task. That is, by setting the protection period, the operation failure of the training task in an extreme case of frequent expansion or reduction is avoided.

In the distributed training task scheduling method provided in the present embodiments, the scheduling state of each training task is acquired first to determine whether resource scheduling needs to be performed on the training task according to the scheduling state of each training task. For the unsuccessfully-scheduled first training tasks, the idle resource quantity of the cluster resource and the minimum resource demand of the first training tasks are acquired, whereby the minimum resource demand required for operation is allocated to the first training tasks, thereby avoiding termination of subsequent training of unsuccessfully-scheduled training task caused by insufficient cluster resource, and improving the resource utilization rate. When the idle resource quantity is greater than the minimum resource demand, task scheduling is performed on the first training tasks based on the idle resource quantity, thereby avoiding termination of subsequent training of the unsuccessfully-scheduled training task caused by insufficient cluster resource, and improving the resource utilization rate. For the second training tasks with the successfully scheduling state, the current idle resource quantity of the cluster resource is acquired to determine whether the resources of the second training tasks may be expanded, thereby reducing a ratio of idle resources in the cluster, and improving the overall resource utilization rate of the cluster. Therefore, the present embodiments of the present application may greatly improve the resource utilization rate and fault-tolerant capability, and shorten the model training cycle.

The present embodiments further provide a distributed training task scheduling apparatus. The apparatus is configured to implement the foregoing embodiments and implementations. Those that are already stated are not repeated herein. As used below, a term “module” may be a combination of software and/or hardware that implements a predetermined function. Although the apparatus described in the following embodiments is implemented by software, the apparatus may also be implemented by the hardware, or a combination of software and hardware.

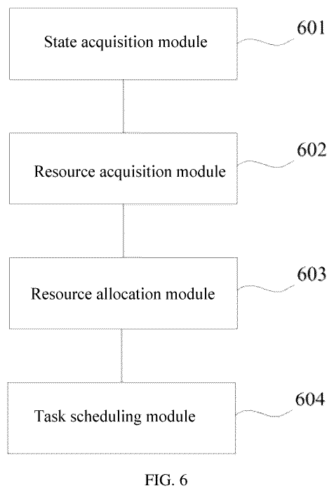

The present embodiments provide a distributed training task scheduling apparatus, as shown in FIG. 6, which includes:
a state acquisition module 601, configured to acquire a scheduling state of each training task, the scheduling state including a successful scheduling state and an unsuccessful scheduling state.

In some implementations, the state acquisition module 601 includes:
an information acquisition unit, configured to acquire training task information of a cluster based on a local information copy; and
a task list determining unit, configured to determine a scheduling training task list according to the training task information.

In some embodiments, a training task is acquired according to the training task information; scheduling training tasks are selected from the training tasks, and a scheduling training task list is generated based on the scheduling training tasks.

A training task determining unit is configured to determine the scheduling state of each training task based on the scheduling training task list.

In some embodiments, the scheduling state further includes a protection marker, and the protection marker is configured to determine whether the corresponding training task is in a protection period, where resource allocation may be performed on the training task that is not in the protection period.

A resource acquisition module 602 is configured to acquire an idle resource quantity of a target cluster resource and a minimum resource demand of first training tasks, for the first training tasks with the unsuccessfully scheduling state.

A resource allocation module 603 is configured to select a training task with an allocatable resource from second training tasks with the successfully scheduling state if the idle resource quantity is less than the minimum resource demand, to obtain the allocatable resource.

In some implementations, the resource allocation module 603 includes:
a minimum resource quantity determining unit, configured to acquire instance information carried in the first training tasks; determine a minimum instance set based on the instance information; and determine a minimum resource quantity required for proper operation of the first training tasks according to a quantity of resources occupied by each instance in the minimum instance set;
a resource quantity determining unit, configured to calculate a resource quantity difference between the idle resource quantity and the minimum resource demand;
a task selection unit, configured to select a target training task that is not in the protection period and satisfies a resource allocation condition from the second training tasks with the successfully scheduling state, where the resource allocation condition includes a condition that a resource quantity of the second training tasks is greater than a minimum resource demand of the second training tasks; and
a resource preemption unit, configured to perform resource preemption task scheduling on a preemptable resource in the target training task, to obtain the allocatable resource.

In some embodiments, the first training tasks are added into a preemption task queue; the first training tasks in the preemption task queue are sorted; and the preemptable resource in the target training task is preempted sequentially.

In some embodiments, when the preemptable resource in the target training task is preempted sequentially, first
the instance information corresponding to the resource quantity difference is acquired; a difference instance set is determined based on the instance information; and resources of each instance in the target training task are preempted according to an order of the resource quantities occupied by each instance in the difference instance set.

A first marking unit is configured to add a protection marker to the preempted target training task, to cause the preempted target training task to be in the protection period.

In some implementations, the resource allocation module 603 is further configured to perform task scheduling on the first training tasks based on the idle resource quantity if the idle resource quantity is equal to the minimum resource demand.

A task scheduling module 604 is configured to perform task scheduling on the first training tasks based on the allocatable resource and the idle resource quantity.

In some implementations, the task scheduling module 604 is further configured to perform task scheduling on the first training tasks based on the idle resource quantity if the idle resource quantity is greater than the minimum resource demand.

In some implementations, the apparatus further includes:
a resource quantity acquisition module, configured to acquire a current idle resource quantity of a cluster resource for the second training tasks with the successfully scheduling state; and
a resource expansion module, configured to expand resources corresponding to the second training tasks based on the current idle resource quantity, to increase the resources corresponding to the second training tasks.

In some embodiments, the resource expansion module includes:
a task acquisition unit, configured to acquire second training tasks that satisfy an expansion condition and are not in the protection period, where the expansion condition includes a condition that a resource quantity of the second training tasks is not a maximum resource demand;
a task sorting unit, configured to add the second training tasks into an expansion task queue, and sort the second training tasks in the expansion task queue; and
a resource expansion unit, configured to sequentially perform an expansion operation on the second training tasks, to increase the resources corresponding to the second training tasks.

In some embodiments, when the resource quantity of the second training tasks reaches the maximum resource demand, the second training tasks are removed from the expansion task queue; or when the expansion task queue is void, the expansion operation is stopped.

In some embodiments, an expansion-available resource in the idle resources is acquired; and when a utilization rate of the expansion-available resource reaches a utilization threshold, the expansion operation is stopped, where when the expansion-available resource includes multiple types of resources, a resource with a maximum utilization rate in the multiple types of resources is compared with the utilization threshold.

A second marking unit is configured to add a protection marker to each expanded second training task, to cause each expanded second training task to be in the protection period.

A scheduling operation updating module is configured to add a task scheduling operation to an operation list, and update a scheduling operation result into a local information copy.

An expansion operation updating module is configured to add the expansion operation to the operation list when succeeding in expansion, and update an expansion operation result into the local information copy.

An information saving module is configured to save acquired cluster information and training task information as the local information copy. The cluster information includes a cluster resource and utilization information of the cluster resource.

Detailed functional descriptions of the modules and units are the same as those of the aforementioned corresponding embodiments, and are not repeated here.

In the present embodiments, the distributed training task scheduling apparatus is presented in a form of functional units, where the units refer to application specific integrated circuits (ASICs), processors and memories that execute one or more software or fixed programs, and/or other devices that may provide the aforementioned functions.

Some embodiments of the present application further provide a computer device, which is provided with the distributed training task scheduling apparatus shown in FIG. 6.

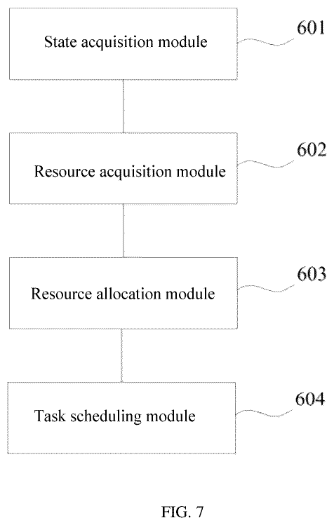

Referring to FIG. 7, FIG. 7 is a schematic structural diagram of a computer device according to some embodiments of the present application. As shown in FIG. 7, the computer device includes one or more processors 10, a memory 20, and an interface configured to connect all components and including a high-speed interface and a low-speed interface. All components are in communication connection with one another by using different buses, and may be installed onto a public main-board or installed in other manners according to the requirements. The processor may process instructions that are executed in the computer device, including instructions stored in or on a memory to display graphical information of a graphical user interface (GUI) on an external input/output device (such as a display device coupled to the interface). In some implementations, a plurality of processors and/or a plurality of buses may be used together with a plurality of memories when necessary. Similarly, a plurality of computer devices may be connected. Each computer device provides necessary operations (such as a server array, a group of blade servers, or a multi-processor system). In FIG. 7, a processor 10 is taken as an example.

The processor 10 may be a central processing unit, a network processor, or a combination thereof. The processor 10 further includes a hardware chip. The hardware chip may be an application specific integrated circuit, a programmable logic device or a combination thereof. The programmable logic device may be a complex programmable logic device, a field programmable logic gate array, a generic array logic or any combination thereof.

The memory 20 stores instructions capable of being executed by the at least one processor 10, whereby the at least one processor 10 executes the method in the foregoing embodiments.

The memory 20 may include a program storage area and a data storage area, where the program storage area may store an operating system and an application program required by at least one function; and the data storage area may store data created by the use of the computer device according to the presentation of a mini program landing page, etc. Furthermore, the memory 20 may include a high-speed random access memory and a non-transitory memory, such as at least one disk storage device, a flash storage device, or other non-transitory solid-state storage devices. In some implementations, the memory 20 includes a memory that is arranged remotely relative to the processor 10. These remote memories may be connected to the computing device through a network. Examples of the network include, but are not limited to the Internet, Intranets, server clusters, mobile communication networks, and combinations thereof.

The memory 20 may include a volatile memory, such as a random access memory; the memory may also include a non-volatile memory, such as a flash memory, a hard disk or a solid-state hard disk; and the memory 20 may also include a combination of the foregoing memories.

The computer device further includes a communication interface 30 that is configured for communication between the computer device and another device or a communication network.

Some embodiments of the present application further provide a non-volatile readable storage medium, where the method according to the embodiments of the present application may be implemented in hardware, or firmware, or may be implemented as a computer code that may be recorded in the non-volatile readable storage medium, or downloaded through a network and originally stored in a remote non-volatile storage medium or a non-transitory machine non-volatile readable storage medium and may be stored in a local non-volatile readable storage medium, whereby the method described herein may be processed by the software that is stored in the non-volatile storage medium of a general-purpose computer, a dedicated processor, or programmable or dedicated hardware. The non-volatile readable storage medium may be a magnetic disk, an optical disk, a read-only memory, a random access memory, a flash memory, a hard disk or a solid-state hard disk. In some embodiments, the non-volatile storage medium may also include a combination of the above kinds of memories. It should be understood that a computer, a processor, a microprocessor controller or programmable hardware includes a storage component that may store or receive the software or computer code, and when the software or computer code is accessed and executed by the computer, the processor, or the hardware, the method shown in the above embodiments is implemented.

Although the embodiments of the present application are described in combination with the drawings, those skilled in the art may make various modifications and variations without departing from the spirit and scope of the embodiments of the present application, and the modifications and variations shall fall within the scope defined by the appended claims.

1. A distributed training task scheduling method, comprising:
acquiring a scheduling state of each training task, the scheduling state comprising a successful scheduling state and an unsuccessful scheduling state;
acquiring an idle resource quantity of a target cluster resource and a minimum resource demand of first training tasks, for the first training tasks with the unsuccessfully scheduling state;
selecting a training task with an allocatable resource from second training tasks with the successfully scheduling state if the idle resource quantity is less than the minimum resource demand, to obtain the allocatable resource; and
performing task scheduling on the first training tasks based on the allocatable resource and the idle resource quantity;
wherein the selecting a training task with an allocatable resource from second training tasks with the successfully scheduling state, to obtain the allocatable resource comprises:
calculating a resource quantity difference between the idle resource quantity and the minimum resource demand;
selecting a target training task that is not in a protection period and satisfies a resource allocation condition from the second training tasks with the successfully scheduling state based on the resource quantity difference, wherein the resource allocation condition comprises a condition that a resource quantity of the second training tasks is greater than a minimum resource demand of the second training tasks; and
performing resource preemption task scheduling on a preemptable resource in the target training task to obtain the allocatable resource.

2. The method according to claim 1, wherein the scheduling state further comprises a protection marker, and the protection marker is configured to determine whether a corresponding training task is in the protection period, wherein a resource allocation may be performed on a training task that is not in the protection period.

3. (canceled)

4. The method according to claim 2, further comprising:
adding the protection marker to preempted target training task, to cause the preempted target training task to be in the protection period.

5. The method according to claim 2, wherein the performing resource preemption task scheduling on a preemptable resource in the target training task comprises:
adding the first training tasks into a preemption task queue;
sorting the first training tasks in the preemption task queue; and
sequentially performing preemption task scheduling on the preemptable resource in the target training task.

6. The method according to claim 5, wherein the sequentially performing preemption task scheduling on the preemptable resource in the target training task comprises:
acquiring instance information corresponding to the resource quantity difference;
determining a difference instance set according to the instance information; and
preempting resources of each instance in the target training task based on a size order of resource quantities occupied by each instance in the difference instance set.

7. The method according to claim 1, further comprising:
performing the task scheduling on the first training tasks based on the idle resource quantity in response to a determination that the idle resource quantity is equal to the minimum resource demand.

8. The method according to claim 6, further comprising:
adding a task scheduling operation to an operation list, and updating a scheduling operation result into a local information copy.

9. The method according to claim 2, further comprising:
performing the task scheduling on the first training tasks based on the idle resource quantity in response to a determination that the idle resource quantity is greater than the minimum resource demand;
acquiring a current idle resource quantity of a cluster resource for the second training tasks with the successfully scheduling state; and
expanding resources corresponding to the second training tasks based on the current idle resource quantity, to increase the resources corresponding to the second training tasks.

10. The method according to claim 9, wherein the expanding resources corresponding to the second training tasks based on the current idle resource quantity, to increase the resources corresponding to the second training tasks comprises:
acquiring second training tasks that satisfy an expansion condition and are not in the protection period, wherein the expansion condition comprises a condition that the resource quantity of the second training tasks is not a maximum resource demand;
adding the second training tasks into an expansion task queue, and sorting the second training tasks in the expansion task queue; and
sequentially performing an expansion operation on the second training tasks, to increase the resources corresponding to the second training tasks.

11. The method according to claim 10, further comprising:
adding the expansion operation to an operation list when succeeding in expansion, and updating an expansion operation result into a local information copy.

12. The method according to claim 10, further comprising:
adding the protection marker to each expanded second training task, to cause the expanded second training task to be in the protection period.

13. The method according to claim 10, further comprising:
removing the second training tasks from the expansion task queue when the resource quantity of the second training tasks reaches the maximum resource demand;
or stopping the expansion operation when the expansion task queue is void.

14. The method according to claim 10, further comprising:
acquiring an expansion-available resource from idle resources; and
stopping the expansion operation when a utilization rate of the expansion-available resource reaches a utilization threshold, wherein when the expansion-available resource comprises multiple types of resources, a resource with a maximum utilization rate in the multiple types of resources is compared with the utilization threshold.

15. The method according to claim 1, wherein calculating the minimum resource demand comprises:
acquiring instance information carried in the first training tasks;
determining a minimum instance set according to the instance information; and
determining the minimum resource demand for proper operation of the first training tasks according to a quantity of resources occupied by each instance in the minimum instance set.

16. The method according to claim 15, wherein the acquiring a scheduling state of each training task comprises:
acquiring training task information of a cluster based on a local information copy;
determining a scheduling training task list according to the training task information; and
determining the scheduling state of each training task based on the scheduling training task list.

17. The method according to claim 16, wherein the determining a scheduling training task list according to the training task information comprises:
acquiring a plurality of training tasks according to the training task information; and
selecting scheduling training tasks from the plurality of training tasks, and generating the scheduling training task list based on the scheduling training tasks.

18. The method according to claim 16, comprising:
saving acquired cluster information and the training task information as the local information copy, wherein the cluster information comprises a cluster resource and utilization information of the cluster resource.

19. (canceled)

20. A computer device, comprising:
a memory and a processor, wherein the memory and the processor are in communication connection with each other, the memory has computer instructions stored therein, the processor executes the computer instructions to execute a distributed training task scheduling method, comprising:
acquiring a scheduling state of each training task, the scheduling state comprising a successful scheduling state and an unsuccessful scheduling state;
acquiring an idle resource quantity of a target cluster resource and a minimum resource demand of first training tasks, for the first training tasks with the unsuccessfully scheduling state;
selecting a training task with an allocatable resource from second training tasks with the successfully scheduling state if the idle resource quantity is less than the minimum resource demand, to obtain the allocatable resource; and
performing task scheduling on the first training tasks based on the allocatable resource and the idle resource quantity;
wherein the selecting a training task with an allocatable resource from second training tasks with the successfully scheduling state, to obtain the allocatable resource comprises:
calculating a resource quantity difference between the idle resource quantity and the minimum resource demand;
selecting a target training task that is not in a protection period and satisfies a resource allocation condition from the second training tasks with the successfully scheduling state based on the resource quantity difference, wherein the resource allocation condition comprises a condition that a resource quantity of the second training tasks is greater than a minimum resource demand of the second training tasks; and
performing resource preemption task scheduling on a preemptable resource in the target training task to obtain the allocatable resource.

21. A computer readable storage medium, having computer instructions stored therein, wherein the computer instructions are configured to enable a computer to execute a distributed training task scheduling method comprising:
acquiring a scheduling state of each training task, the scheduling state comprising a successful scheduling state and an unsuccessful scheduling state;
acquiring an idle resource quantity of a target cluster resource and a minimum resource demand of first training tasks, for the first training tasks with the unsuccessfully scheduling state;
selecting a training task with an allocatable resource from second training tasks with the successfully scheduling state if the idle resource quantity is less than the minimum resource demand, to obtain the allocatable resource; and
performing task scheduling on the first training tasks based on the allocatable resource and the idle resource quantity;
wherein the selecting a training task with an allocatable resource from second training tasks with the successfully scheduling state, to obtain the allocatable resource comprises:
calculating a resource quantity difference between the idle resource quantity and the minimum resource demand;
selecting a target training task that is not in a protection period and satisfies a resource allocation condition from the second training tasks with the successfully scheduling state based on the resource quantity difference, wherein the resource allocation condition comprises a condition that a resource quantity of the second training tasks is greater than a minimum resource demand of the second training tasks; and
perform resource preemption task scheduling on a preemptable resource in the target training task to obtain the allocatable resource.

22. The method according to claim 10, wherein the sorting the second training tasks in the expansion task queue comprises:
sorting the second training tasks in the expansion task queue according to an ascending order of minimum resources required for operations of the second training tasks; or
sorting the second training tasks in the expansion task queue according to creation time of the second training tasks and an unsuccessfully-scheduled order.
